(19) United States
(12) Patent Application Publication
(10) Pub. No.: US 2016/0227965 A1
(43) Pub. Date: Aug. 11, 2016

(54) Locking Insert and Modified Cooking Grate for Barbecue Grills

(71) Applicant: Landmann USA, Fairburn, GA (US)

(72) Inventors: Todd Johnston, Fairburn, GA (US); Tim Braaten, Columbus, GA (US)

(21) Appl. No.: 14/619,475

(22) Filed: Feb. 11, 2015

(51) Int. Cl. A47J 37/07; A47J 37/06

(52) U.S. Cl. CPC A47J 37/0763; A47J 37/067; A47J 37/0704

(57) ABSTRACT

For use with a barbecue grill, a locking insert mounted to the firebowl of the grill and having a slot or slots formed in its upper rim. A cooking grate having a bar or bars underlying the cooking surface is disposed over the insert, the bars mating with the slots to secure the grate in a defined position. The grate has laterally extending handles for lifting the grate and the grill hood off of the insert for replenishing spent fuel.

### BACKGROUND

Outdoor barbecue cooking is a popular method of preparing food throughout the world. Barbecue grills come in myriad sizes, shapes, styles, and fuel sources. For example, grills can be round, square, rectangular, tall, short, fixed-in-place, cart mounted, portable, light, heavy, and so on. Similarly, grills can be fueled by burning wood, charcoal, LP (liquid propane), butane, and/or natural gas, electrical elements, etc.

Equally vast are the varieties of foods that can be and are cooked on barbecue grills. Meats, fish, poultry, vegetables, fruits, breads, as well as fully prepared dishes, such as casseroles, can all be prepared over hot coals, gas burners, and the like. The variety of cooking means and foods to cook are virtually endless, limited only by the skill and creativity of the chef.

A relatively recent addition to the line-up of foodstuffs suitable for grilling is pizza. Pizza, often called pizza pie, comes in a variety of forms; i.e., thin crust, thick crust, deep dish, and so on; and can also contain a wide variety of ingredients. In general; however, pizza comprises a base layer of bread-type, cracker, or doughy crust, a layer of sauce, e.g. tomato sauce, cheese, and from there, virtually any edible item that is used as a topping. When made and ready to be cooked, a pizza, in general, is relatively soft and flexible, thus requiring a hard, flat surface for cooking.

When cooked on a barbecue grill, a substantially solid, heat conducting base, termed a pizza stone, or like expedient, is used for supporting the pizza within the barbecue grill, where a typical support surface is a wire cooking grate. Whatever is used for the supporting base, it is normally a conductor of heat in order to facilitate cooking, sturdy enough to withstand the elevated temperatures associated with grilling, and possessing of a hard, flat, surface, so as to facilitate the placement and removal of the pizza when cooked.

U.S. Patent Application Publication No. US2011/0214662A1 to Contarino Jr. details an accessory that is used to convert a common barbecue grill, such as a kettle style grill, to an oven-type enclosure for grilling pizza and other foods that are not particularly suited to being cooked on a cooking grate, or being cooked on a barbecue grill itself.

The application teaches a cylindrical insert, round in the example so as to follow the shape of the kettle grill, open at the top and bottom, and designed to fit between the firebox and the hood or lid of the grill. The insert is of a gauge substantial enough to withstand the high temperature of grilling and to support the weight of the grill hood. A window is formed in the side of the insert and used for inserting and withdrawing foods cooked in the grill. A ceramic stone or like means is placed over the cooking grate to support the pizza or other foods. This application is incorporated by reference in its entirety.

While the conversion device performs well for its intended use, the present application teaches improvements that have been designed to further enhance the utility of the barbecue grill as a cooking device.

### SUMMARY

The present application teaches a locking insert and a modified cooking grate assembly for use with a grill according to the Contarino, Jr. application or with other barbecue grills. The insert is mounted on the firebox and receives and supports the insert with the window, the cooking grate, the cooking stone, and the grill hood. The cooking grate includes elongated handles and integral feet for supporting the grate on a stable surface upon its removal from the grill. The assembly may also be used with other conventional grills that do not use the insert with the window.

Various additional objects and advantages of the present locking insert and modified grate will become evident from the description hereinbelow, taken in conjunction with the accompanying drawings.

### BRIEF DESCRIPTION OF THE DRAWINGS

FIG. 1 is an exploded, perspective view of the present locking insert and modified cooking grate, illustrating their relative positions in a kettle-type grill;

FIG. 2 is a partial, exploded, perspective view showing the locking insert, grate, and circular insert with the window;

FIG. 3 is a partial, cross-sectional view showing the assembled condition of the locking insert and grate;

FIG. 4 is a partial, exploded, perspective view illustrating the assembly in working form; and

FIG. 5 is a partial, cross-sectional view showing the grill assembled without the insert having the window.

### DETAILED DESCRIPTION

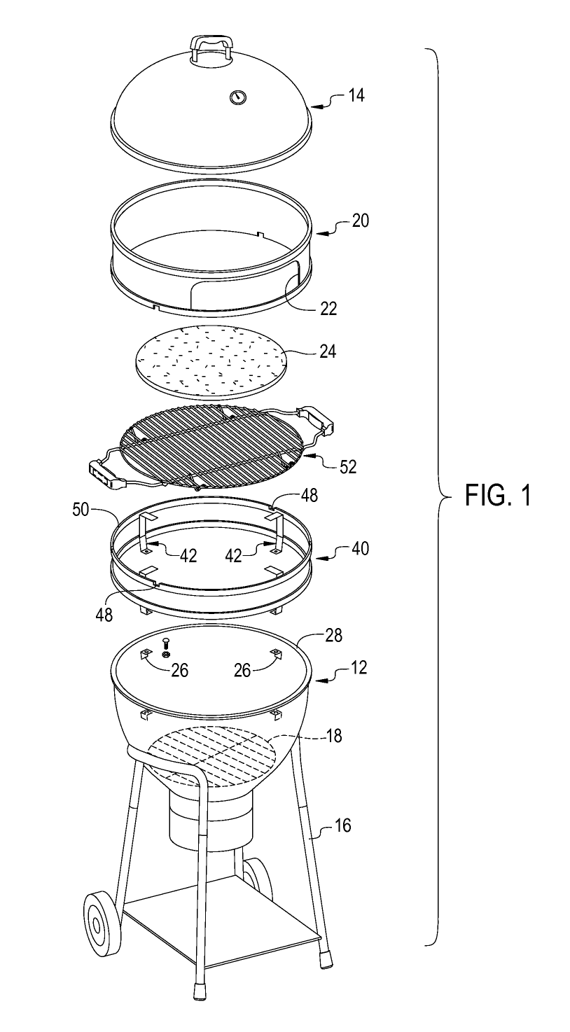

Referring now more specifically to the drawings, and to FIG. 1 in particular, numeral 10 designates generally a kettle grill, shown here in exploded format. The kettle grill has a firebowl 12 and a hood 14 and is mounted for portability on cart 16. Inside the firebowl is a coal grate 18 that supports whatever combustible material is used for cooking, i.e. charcoal briquettes, wood chunks, etc. The firebowl can also contain alternative heat sources such as a gas burner or burners, electric elements, and the like.

In the Contarino, Jr. application, insert 20 with its window 22 is mounted on the firebowl 12, supported thereon by the upper rim 28 of the firebowl; or it is mounted inside the firebowl, supported by the original equipment cooking grate (not shown). The pizza stone 24 is mounted in the firebowl, either on the original equipment lugs (not shown) that normally support the cooking grate, or on the original grate itself.

As discussed in the Contarino, Jr. application, the cooking fuel, e.g. charcoal, is piled near the rear of the firebowl. The combination of the localized fuel, the shape of the kettle enclosure, and the vents in the firebowl and hood, generate a draft and thus, a tremendous amount of heat. Temperatures upwards of 600-700° F. and higher are common and necessary for successfully grilling pizza. However, the factors that generate the extreme heat also rapidly consume the fuel. In order to grill multiple pizzas, or other foods, it is necessary to replenish the fuel supply. In order to replenish the fuel in the Contarino, Jr. device, the hood, pizza stone, and cooking rack must be removed and replaced, individually, and in sequential order. This is, of course, complicated by the extreme temperatures.

To address this issue, the present Applicants have devised a novel solution. Referring again to FIG. 1, firebowl 12 is modified with the addition of L-shaped tabs 26, disposed inside the firebowl below the upper rim 28. The circular insert 20 is removed and replaced by the present locking insert 40. While the description references a locking insert, it is to be understood that the locking insert is a solid walled insert designed to mate with the firebowl and, as such, will be made in the shape of the firebowl, e.g. round, square, rectangular, etc. The cooking grate will then be similarly shaped and any such variations are considered to be within the scope of the present disclosure.

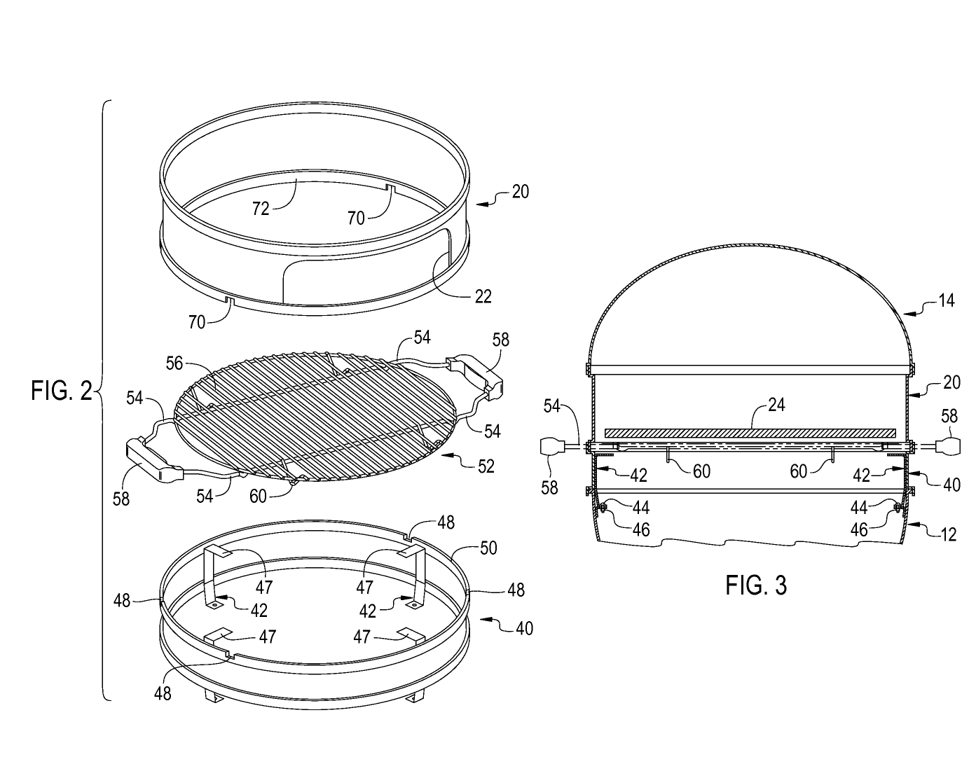

The locking insert 40 includes at least one, and in the embodiment shown, a plurality of C-shaped brackets 42. The lower ends of brackets 42 are secured to tabs 26 with screws, bolts 44 and nuts 46, (as shown in FIG. 5), rivets, or some other type of fastener. The lower, outer rim of the insert 40 is flared outwardly to encircle and cover the upper rim of the firebowl, providing a substantially sealed engagement therewith. The locking insert can be permanently, or, at least semi-permanently, attached to the firebowl 12, as shown in FIG. 3, effectively making the firebowl deeper and facilitating the draft effect which helps to achieve the elevated temperatures needed to grill pizzas or other foods. The upper ends of the C-shaped brackets extend inwardly from ring 40 to form horizontal supports 47, which are disposed generally parallel to the base or ground, for use as described hereinbelow.

Insert 40 also includes at least one, and in the embodiment shown, a plurality of slots 48, which are formed in the upper rim 50 of insert 40. In this embodiment, four such slots 48 are provided, generally opposite one another in the lengthwise, or side-to-side, direction of the firebowl. The horizontal supports 47 are configured such that the top surface of each support is disposed in substantially the same horizontal plane as the bottoms of the slots 48.

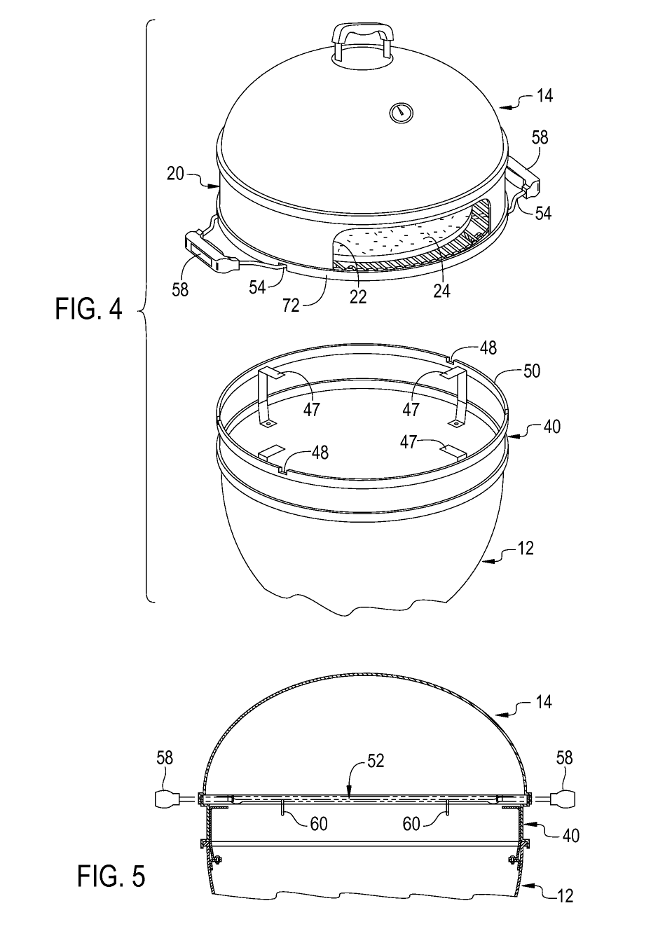

In the Contarino, Jr. device, the original equipment grill surface, i.e. a cooking grate, is discussed in paragraph 0031 as being mounted on supports 105, shown in FIG. 4B. The OE grill surface is not illustrated, but in grills of this type, the grill surface is supported in the interior of the firebowl and is completely covered by the grill hood. This arrangement facilitates the generally sealed environment of a kettle-type grill, which utilizes the restriction of influent oxygen to control flare-ups. Without a cooking surface in place, the supports 105 are used to mount the pizza stone, typically a heavy, round, ceramic or stone element on which the pizza is cooked.

In the present device, modified cooking grate 52 is provided, as shown in FIGS. 1-5. Referring to FIG. 2, the grate can comprise a circular element having a succession of closely spaced wire rods that are used either to support food being cooked over the heat source or, as shown in FIG. 3, the pizza stone 24. While shown as a circular, wire grate, the grate can be made in different shapes, generally corresponding to the shape of the firebowl and hood, and with many different materials that can withstand the heat used for cooking food thereon, such as steel, aluminum, ceramics, and the like. The cooking grate can also be cast iron, aluminum bars, ceramic rods, or other suitable material. The configuration of the grate can also take various forms, using circular elements, elongated bars, flat surfaces, rectangular surfaces, and the like. Cooking grate 52 is modified using at least one, and in some embodiments, a plurality of elongated, lengthwise, horizontal bars 54 that underlie and support the food support rods 56. The bars 54 are extended radially outwardly from the grate 52 on each side, and converge on each side thereof to where they terminate in grate handles 58.

When the grate is placed over the locking insert 40, the outer ends of bars 54 are received in the slots 48 in the upper rim of insert 40. This arrangement locks the grate in place against rotating, and also signals to the user that the grate is correctly seated with the handles 58 disposed outwardly of the firebowl. Localized portions of the food support rods are received on top of supports 47, further ensuring a stably mounted surface. In addition, at least one, and in this embodiment, a plurality of rods 56 are bent downwardly to form V-shaped supports 60, below the cooking grate 52. These supports 60 serve as feet to suspend the grate 52 over another supporting surface, as described more fully hereinbelow.

Referring again to FIG. 2, in order to convert the insert 20 of Contarino, Jr. to be usable with the present locking insert and modified cooking grate, the insert 20 is modified to include at least one, and in this embodiment, a plurality of downwardly facing slots 70, formed in the bottom rim 72 of insert 20. The bottom rim 72 is flared outwardly to fit over the upper rim 50 of the locking ring 40. The downwardly facing slots 70 fit over the grate bars 54, as shown in FIG. 4, where the various elements are shown assembled. The combination of the grate bars 54 and the complementary-formed slots 48 and 70, serve to help seal what would otherwise be an unobstructed pathway for the ingress of air and the egress of heat, each with its own possibly deleterious effect on the cooking process.

As discussed hereinabove, the design of the Contarino, Jr. device makes it effective for achieving the high temperatures required to successfully grill pizzas, but also requires that the fuel be replenished for grilling multiple pizzas or other foods due to the fact that the draft effect created by the deep firebowl, the vents in the firebowl and hood, and the open window in the insert 20, rapidly consumes fuel. Referring to FIG. 4, one of the beneficial effects of the present modifications is illustrated. When it becomes necessary to replenish the fuel, the user grasps the extended handles 58 and lifts the cooking grate, the pizza stone, and the grill hood off of the locking ring as a single unit. The integrity of the unit is maintained by the engagement of the grate bars 54 with the slots 70, formed in the modified circular insert 20. The now separated upper portion of the grill can be then placed on any suitable supporting surface, resting on the V-shaped supports 60. This provides direct access to the firebowl for adding more fuel, i.e. charcoal, wood chunks for flavoring, etc. After adding the fuel, the entire upper portion is replaced on the locking insert, the reception of the grate bars 54 in the slots 48 indicating to the user that the upper portion is securely seated and locked in place for further use. Exact registering of the bars 54 with slots 48 is not a requirement during the replacement of the upper assembly as the bars 54, upon making resting contact with the upper rim 50 of the locking insert, support the assembly while a slight rotation of the assembly in one direction or the other will result in registry of the bars with the slots. As the seating is a positive engagement that can be felt even if not seen, given the environment, the user is assured that the grate, stone, and hood have been securely and safely re-positioned in a defined orientation over the firebowl.

While discussed above with relation to the Contarino, Jr. application, the present locking insert and modified cooking grate assembly can also be used with virtually any grill type of virtually any shape, e.g. kettle-type grills, rectangular or square grills, hibachi-type grills, etc. As shown in FIG. 5, the locking insert 40 is installed on a typical kettle-type grill firebowl 12. The grate 52 is installed thereon, the bars 54 of the grate being received in the slots 48 of ring 40. Food to be cooked is placed on the grate and the hood 14 is placed over ring 40. The ring is sized to fit just inside the outer rim of the hood, providing a substantially sealed cooking environment while adding the benefit of the deepened firebowl and increased draft effect. For a grill that is not circular, the locking “insert” becomes a locking “spacer”, serving to space the hood farther up from its normal position on top of the firebowl. The cooking grate is similarly modified to conform to the shape of the grill, while providing extended handles that extend beyond the outer perimeter of the grill proper, and bars that lock into slots formed in the locking spacer.

While an embodiment of a locking insert and modified cooking grate has been shown and described in detail herein, various additional changes and modifications may be made without departing from the scope of the present disclosure.

We claim:

1. A locking insert and cooking grate assembly for use with a barbecue grill, the grill having a firebowl and a hood for covering said firebowl, said assembly comprising an insert secured to and conforming to the shape of the firebowl, said insert having an upper rim with at least one slot formed in said rim, a cooking grate having a food supporting surface and at least one bar underlying said food supporting surface and disposed in said slot for locking said grate in a defined position over said firebowl.

2. The assembly as defined in claim 1 in which said insert has a plurality of slots in said upper rim and said grate has a corresponding plurality of bars for registering with said slots.

3. The assembly as defined in claim 2 in which said grate includes handles.

4. The assembly as defined in claim 3 in which said handles are elongated and extend outwardly relative to said insert.

5. The assembly as defined in claim 1 in which said grate includes handles.

6. The assembly as defined in claim 5 in which said handles are elongated and extend outwardly relative to said insert.

7. A barbecue grill comprising a firebowl and a hood, for covering said firebowl, the firebowl and hood having a complementary, defined shape, a locking spacer, having the same defined shape as said firebowl, mounted above said firebowl and including an upper rim, and a cooking grate mounted above said locking spacer, said grate being supported by said upper rim for receiving and supporting food to be cooked on the grill.

8. The barbecue grill as defined in claim 7 in which said locking spacer has a defined height and solid walls for maintaining the enclosure formed by said firebowl and hood.

9. The barbecue grill as defined in claim 8 in which said locking spacer has at least one slot formed in said upper rim.

10. The barbecue grill as defined in claim 9 in which said cooking grate has at least one underlying bar for registering with said slot in said upper rim.

11. The barbecue grill as defined in claim 7 in which said upper rim of said spacer has a plurality of slots formed therein.

12. The barbecue grill as defined in claim 11 in which said cooking grate has a plurality of underlying bars for registering with said slots and locking said grate in a defined position.

13. The barbecue grill as defined in claim 12 in which said cooking grate includes handles projecting radially from said grate in opposite directions.

14. The barbecue grill as defined in claim 13 in which said firebowl and hood have an outer perimeter and said handles extend outside of said perimeter.

15. The barbecue grill as defined in claim 7 in which said cooking grate includes a pair of handles disposed opposite one another and extending radially away from one another outside said defined shape of said firebowl and hood.

16. In a barbecue grill having a firebowl and a hood, each having a complimentary shape, the improvement comprising a locking insert mounted to said firebowl for increasing the relative depth of the firebowl, said insert having an upper rim with a plurality of slots formed in said upper rim, a cooking grate having a food supporting surface with a plurality of bars disposed below said food supporting surface and correspondingly received in said slots for locking said grate against rotation and locating said grate over said firebowl.

17. The assembly as defined in claim 16 in which said grate includes handles.

18. The assembly as defined in claim 17 in which said handles are elongated and extend outwardly relative to said insert.
